(19) United States
(12) Patent Application Publication
(10) Pub. No.: US 2015/0093536 A1
(43) Pub. Date: Apr. 2, 2015

(54) Polyisobutylene-Based Encapsulant for use with Electronic Components

(71) Applicant: Itron, Inc., Liberty Lake, WA (US)

(72) Inventors: Satish Bhakta, Minnetonka, MN (US); Cory Klemmensen, New Richland, MN (US); Gediminas Markevicius, Spokane, WA (US); Matt Mueller, Eagle Lake, MN (US); Brian Fitzloff, Mankato, MN (US)

(73) Assignee: Itron, Inc., Liberty Lake, WA (US)

(21) Appl. No.: 14/040,433

(22) Filed: Sep. 27, 2013

(51) Int. Cl. H01B 3/44; H01B 17/56; H01B 19/04

(52) U.S. Cl. CPC H01B 3/441; H01B 19/04; H01B 17/56
USPC 428/76; 427/58; 524/505

(57) ABSTRACT

An encapsulant for use with electronic components. The encapsulant includes a polyisobutylene, a tackifier, a polymer, and a thermoplastic elastomer. In one example, the encapsulant is applied to an electronic component at a temperature ranging from about 100° C. to about 150° C. to provide a moisture barrier when the encapsulant cools.

### BACKGROUND

Automatic meter reading (AMR) technology used in conjunction with utility meters, and particularly water meters, must generally operate in relatively harsh environments. For example, water meters and AMR components placed in water meter pits are exposed to high humidity levels almost constantly. Additionally, meters and associated components placed into pits are potentially subjected to corrosion due to contact with various corrosive liquids. Often designers try to design the meter components from materials that are capable of withstanding exposure to moisture and/or corrosive liquids. Another option is to hermetically seal the housings containing any electronic components, though this is often not a desired approach because of manufacturing constraints and high costs. Still another approach is to try to insulate any electronic components associated with utility meters from harsh environments through the use of various encapsulants or potting materials.

In cases where electrical components are located in harsh environments, a method for coating or encasing electronics with a potting material or encapsulant with a decreased diffusion rate that corresponds with improved moisture protection and shields the components from corrosive liquids is desirable. While silicones, polyurethanes, and epoxies have been developed as potting materials and can provide some protection against moisture, thermal shock, and vibration, such potting materials/encapsulants still allow for the penetration of moisture over time due to their higher permeability and diffusion rates. Thus, these materials do not sufficiently waterproof the electrical components that they surround.

Prior publications that describe potting materials or encapsulants include U.S. Pat. No. 7,999,016 to Osada et al. disclosing a “Semiconductor Encapsulating Epoxy Resin and Semiconductor Device,” U.S. Pat. No. 7,763,673 to Okamoto et al. disclosing a “Curable Composition Containing a Silicon-Containing Group Polymer, a Titanium Chelate, and an Amide Wax,” U.S. Pat. No. 7,741,388 to Murotani et al. disclosing an “Epoxy Resin Composition and Semiconductor Device,” U.S. Pat. No. 4,977,009 to Anderson et al. disclosing “Composite Polymer/Dessicant Coatings for IC Encapsulation,” U.S. Patent Application Publication No. 2010/0067168 by Summers et al. disclosing “Composite Organic Encapsulants,” U.S. Pat. No. 8,481,626 to Bhakta et al. disclosing “Wax-Based Encapsulant/Moisture Barrier for Use with Electronics Received in Water Meter Pits,” and U.S. Patent Application Publication No. 2013/0183437 to Bhakta et al. disclosing “Method for Encapsulation of Electronics Received in Water Meter Pits with an Improved Wax-Based Encapsulant/Moisture Barrier.” The complete disclosures of such patent publications are fully incorporated herein by reference for all purposes.

While various methods have been developed for potting or encapsulating electronic components, providing some level of protection from harsh environments, no particular method of dispensing an encapsulant composition onto electronic components has emerged that encompasses all of the desired characteristics as hereafter presented in accordance with the subject technology.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIG. 1 illustrates an example utility meter pit configuration including one or more components encapsulated according to the description herein;

FIG. 2 illustrates an exploded view of an assembly including encapsulated electronic circuitry that may be present in AMR technology in utility meter pits;

FIG. 3 illustrates a perspective view of an encapsulated electronic sub-assembly that may be present in AMR technology in utility meter pits;

FIG. 4 illustrates a meter endpoint circuit board coated with an example encapsulant of the present disclosure;

FIG. 5 illustrates a flowchart of an example process that may be used to encapsulate an electronic component of the present disclosure;

FIG. 6 illustrates a summary of the data comparing a first example of samples of a tested encapsulant of the present disclosure with corresponding controls;

FIG. 7 illustrates a summary of the data comparing a second example of samples of another tested encapsulant of the present disclosure with corresponding controls; and

FIG. 8 illustrates a summary of the data comparing a third example of samples of yet another tested encapsulant of the present disclosure with corresponding controls.

Repeat use of reference characters throughout the present specification and appended drawings is intended to represent same or analogous features, elements, or steps of the presently disclosed subject matter.

### DETAILED DESCRIPTION

An improved polyisobutylene-based encapsulant for use with electronics and a method for encapsulating electronic components used in AMR technology with the improved polyisobuylene-based encapsulant to provide a barrier to protect the electronic environments from harsh environments have been provided.

In one aspect, the present disclosure is directed toward an encapsulant for use with electronic components. The encapsulant may include a polyisobutylene, a tackifier, a polymer, and a thermoplastic elastomer.

In another aspect, the present disclosure is directed toward a method of forming an encapsulant on an electronic component. The method may include heating a polyisobutylene, a tackifier, a polymer, and a thermoplastic elastomer. The heating may occur at a temperature ranging from about 100° C. to about 150° C. The method may additionally include mixing the heated polyisobutylene, tackifier, polymer, and thermoplastic elastomer to form an encapsulant.

Different embodiments of the disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

The presently disclosed subject matter involves a polyisobutylene-based encapsulant that may be used in, for example, AMR technology, or any application where a barrier to moisture or corrosive liquids is desired. Thus, although the polyisobutylene-based encapsulant is generally described in the context of utility meter pits, its use is not to be construed as limited to such technology.

Reference will now be made in detail to examples demonstrating the use of the polyisobutylene-based encapsulant of the present disclosure, followed by a description of the polyisobutylene-based encapsulant, which exhibits improved moisture and gas barrier properties. The presently disclosed subject matter in certain embodiments thereof corresponds to a polyisobutylene-based encapsulant that protects any electrical components used in AMR technology, although the polyisobutylene-based encapsulant may also be used in other applications where electrical components may need to be protected from a harsh environment, such as where moisture or corrosive liquids may be present.

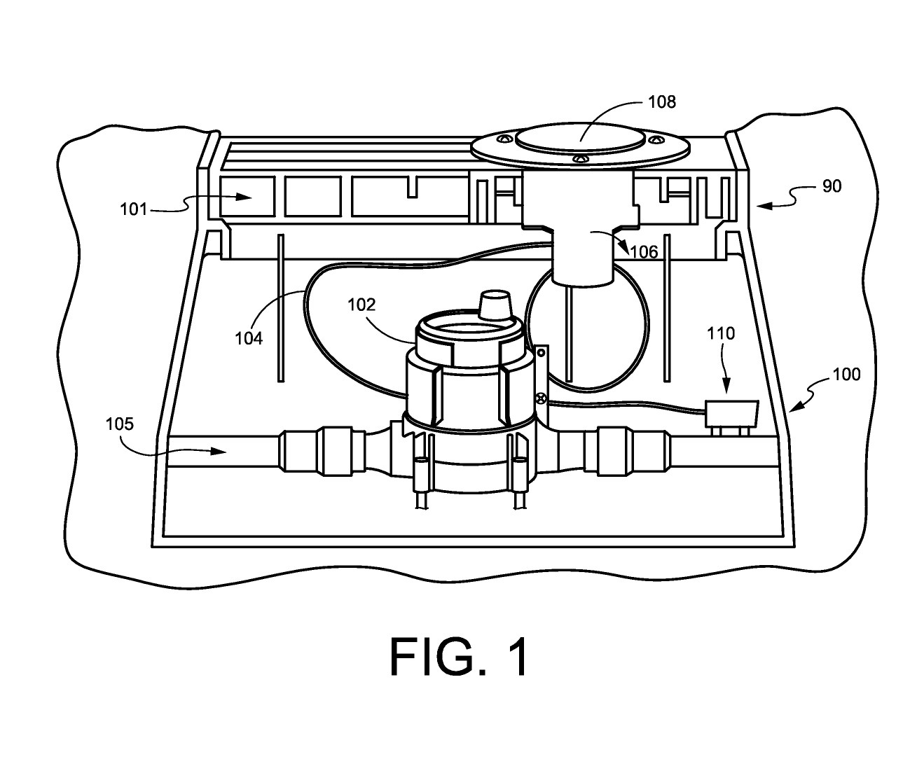

FIG. 1 illustrates an example utility meter assembly 100 containing electronic components coated with an example of the polyisobutylene-based encapsulant of the present disclosure. A utility-meter pit enclosure assembly 90 allows access to below-ground meters, such as a water meter 102 as shown, that are used to measure consumption of water, gas, electricity, and the like. The utility meter assembly 100 is closed with a lid 101 to protect the equipment inside. Components of a utility meter reading system, such as a cable 104, a radio-frequency (RF) transmitter 108, a leak sensor 110, and the like may be located in the utility-meter assembly 100 and associated with, for example, a water pipe 105. An AMR device 106 may include an encoder and an integral RF antenna (not shown). Alternatively, these components can be installed in separate housings and joined with a cable or other connector. The AMR device 106, leak sensor 110, and other components contain electrical circuitry, which can be damaged if contacted by corrosive liquids or moisture. While at least the AMR device 106 can be attached to the pit lid 101 so that it is positioned relatively far from the bottom of the pit to help keep the AMR device 106 away from water and other contaminants that are likely to be present deeper in the pit, the AMR device may still be exposed to extremely humid conditions and/or corrosive liquids. Additionally, other components such as the leak sensor 110 will inevitably be exposed to moisture and possibly corrosive liquids. Thus, the polyisobutylene-based encapsulant of the present disclosure protects those components from the intrusion of such moisture and/or corrosive liquids.

Any and all electronic components of utility meter assembly 100 may be encapsulated with the polyisobutylene-based encapsulant of the present disclosure. For example, cable 104, radio-frequency (RF) transmitter 108, leak sensor 110, the encoder and the integral RF antenna may each be encapsulated with the polyisobutylene-based encapsulant.

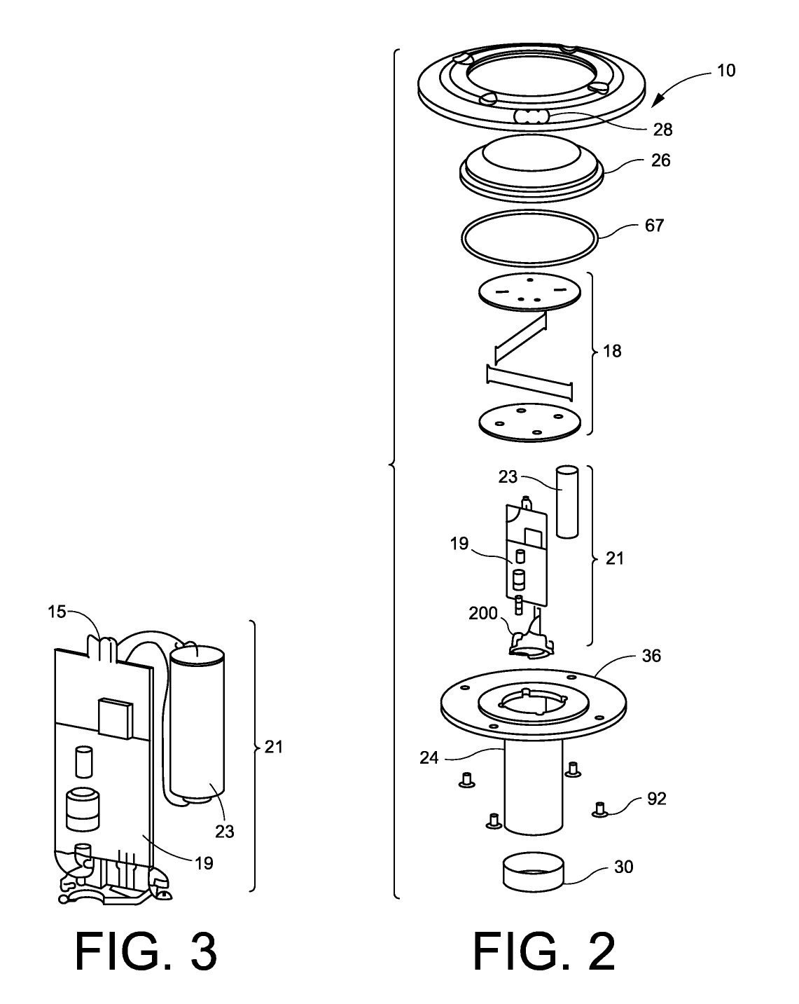

FIG. 2 shows an example exploded view of an assembly that includes a detailed view of the electrical components that may be coated with the polyisobutylene-based encapsulant material in accordance with the present description. FIG. 2 shows an example of a telemetry antenna system 10 with bulkhead 200. A radome 26 is placed in an inverted position into retainer ring 28, and a seal is formed with o-ring 67. While the radome 26 may weatherproof the telemetry antenna system 10 associated with a utility meter pit and AMR technology to some extent, there is still moisture within the pit, and it is still possible that moisture and corrosive liquids can come into contact with components that encompass the telemetry antenna system 10. The radiator sub-assembly 18, telemetry board 19, and battery 23 are housed within the telemetry antenna system 10 between the radome 26 and end cap 30 to protect them from moisture, although there is still the potential for the seepage of moisture or corrosive liquids into the telemetry antenna system 10. As shown, the telemetry board 19 and battery 23 rest in base 24. Screws 92 may be secured to annular plate 36 and retaining ring 28 to complete assembly of base 24 to radome 26 and retainer ring 28.

Any and all electronic components of telemetry antenna system 10 may be encapsulated with the polyisobutylene-based encapsulant of the present disclosure. For example, radiator sub-assembly 18, telemetry board 19, and battery 23 may each be encapsulated with the polyisobutylene-based encapsulant.

FIG. 3 shows an electronic sub-assembly 21 that is also shown as a component of FIG. 2. As is represented by present FIG. 3, the sub-assembly 21 may include a battery 23, a telemetry board 19, and an antenna feed connection 15.

Any and all electronic components of electronic sub-assembly 21 may be encapsulated with the polyisobutylene-based encapsulant of the present disclosure. For example, antenna feed connection 15, telemetry board 19, and battery 23 may each be encapsulated with the polyisobutylene-based encapsulant.

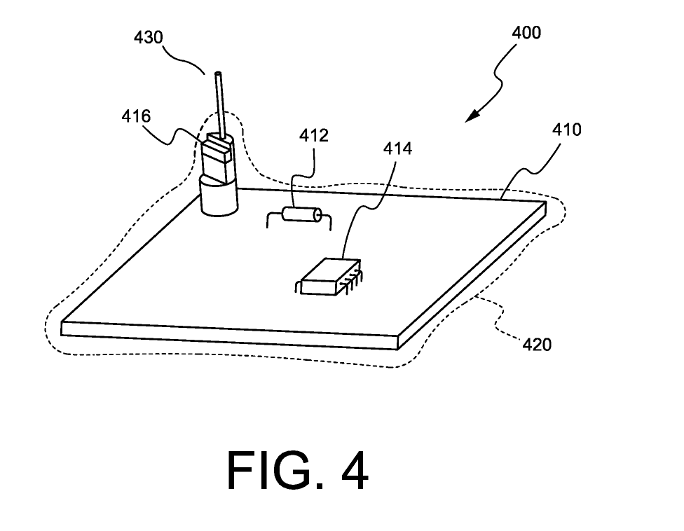

FIG. 4 shows another type of electrical component that may be included in AMR technology. An endpoint circuit board 400 generally incorporating the present encapsulant material 420 is shown. Referring to FIG. 4, an endpoint circuit board 400 includes a supporting substrate corresponding to a printed circuit board (PCB) 410 configured to support and interconnect endpoint components including circuitry components 412 and 414 and at least a portion of a two-part antenna coupler 416. The endpoint circuit board 400 is shown coated in the polyisobutylene-based encapsulant 420 of the present description.

As illustrated in present FIG. 4, the male portion of the two-part antenna coupler 416 may be mounted to PCB 410; an antenna 430 may be affixed to the female portion of two-part antenna coupler 416; and both the male and female portions as well as an end portion of antenna 430 may be coated with polyisobutylene-based encapsulant 420 along with the other components 412 and 414 that are mounted to PCB 410. Those of ordinary skill in the present art will appreciate that exemplary endpoint 400 may be incorporated into a meter module. In certain instances, such meter modules may be installed in a pit and may be located as deep as 3 to 4 feet below local surface level.

The polyisobutylene-based encapsulant may have a melting temperature ranging from about 75 C to about 150° C., and withstand temperatures less than about 100° C. without flowing or melting on cure. The polyisobutylene-based encapsulant may also have a viscosity of less than about 10000 centipoise, at a temperature ranging from about 100° C. to about 150° C. The viscosity at this temperature allows it to be melted and dispensed onto any batteries or other components without causing heat damage or shrinkage of the polyisobutylene-based encapsulant. When dispensed at a temperature of about 100° C. to about 150° C., the polyisobutylene-based encapsulant may have a viscosity ranging from about 125 centipoise to about 10000 centipoise. In another embodiment, the polyisobutylene-based encapsulant may have a viscosity ranging from about 400 centipoise to about 8500 centipoise when dispensed at a temperature of from about 100° C. to about 150° C. In another embodiment, the polyisobutylene-based encapsulant may have a viscosity ranging from about 1500 centipoise to about 3500 centipoise when dispensed at a temperature of from about 100° C. to about 150° C. In another embodiment, the polyisobutylene-based encapsulant may have a viscosity ranging from about 2000 centipoise to about 3000 centipoise when dispensed at a temperature of from about 100° C. to about 150° C. In yet another embodiment, the polyisobutylene-based encapsulant may have a viscosity ranging from about 2200 centipoise to about 2700 centipoise when dispensed at a temperature of from about 100° C. to about 150° C.

The polyisobutylene-based encapsulant may attach to all relevant surfaces to provide barrier properties to water vapor and liquid water. Once attached, the encapsulant provides excellent protection to the enclosed components.

The polyisobutylene-based encapsulant may include polyisobutylene and other components. For example, in addition to polyisobutylene, the polyisobutylene-based encapsulant may include a tackifier, a polymer, and a plasticizer. In other embodiments, the polyisobutylene-based encapsulant may further include an antioxidant. These other components may all include, at least in part, saturated hydrocarbons. Saturated hydrocarbons (alkanes) are the simplest of the hydrocarbon species and are composed entirely of single bonds and are saturated with hydrogen. The general formula for saturated hydrocarbons is CₙH₂ₙ₊₂ (assuming non-cyclic structures). Saturated hydrocarbons are found as either linear or branched species and have chemical stability and waterproofing capabilities.

Polyisobutylene may be used as the base of the polyisobutylene-based encapsulant. The polyisobutylene may have an average molecular weight ranging from about 1000 to about 3350 g/mol and may have a kinematic viscosity ranging from about 190 centipoise to about 4200 centipoise at 100° C. In one embodiment, the polyisobutylene that may be used is TPC® 1105, available from The TPC Group, Inc., which has an average molecular weight of about 1050 g/mol and a kinematic viscosity of about 220 centipoise at 100° C. The polyisobutylene may be present in an amount ranging from about 50% by weight to about 95% by weight of the total polyisobutylene-based encapsulant composition. In another embodiment, the polyisobutylene may be present in an amount ranging from about 65% by weight to about 85% by weight of the total polyisobutylene-based encapsulant composition. In yet another embodiment, the polyisobutylene may be present in an amount of about 75% by weight of the total polyisobutylene-based encapsulant composition.

In addition to polyisobutylene, the polyisobutylene-based encapsulant material may also include a tackifier. Tackifiers are chemical compounds used in formulating adhesives to increase the “tack” or stickiness of a surface of the adhesive. Thus, tackifiers may be used in the polyisobutylene-based encapsulant material to increase the ability of the polyisobutylene-based encapsulant material to coat and adhere to any electrical components. The tackifier may have a low molecular weight, which gives it high tack, a low solution viscosity, as well as a low molten viscosity when used in hot-melt adhesives. Using tackifiers with softening points ranging from about 80° C. to about 105° C. may reduce the moisture vapor transmission rate of the polyisobutylene-based encapsulant material. The tackifier may include a hydrocarbon resin; a glycol ester of partially hydrogenated rosin; a thermoplastic, acid resin; or a thermoplastic ester resin.

In one embodiment, the tackifier may include a hydrocarbon resin having: a softening point in a range of about 80° C. to about 105° C.; an average molecular weight ranging from about 990 g/mol to about 1120 g/mol; and a viscosity ranging from about 610 centipoise to about 1660 centipoise at a temperature of 150° C. In another embodiment, the tackifier may include NEVTAC® 201 (low molecular weight, hydrocarbon resin) which is available from Neville Chemical Company. In other embodiments, tackifiers that may be used include NEVTAC® 80 (low molecular weight, hydrocarbon resin) available from Neville Chemical Company, STAYBELITE™ Ester 5-C Resin (a glycerol ester of partially-hydrogenated rosin), FORAL™ AX-E Fully Hydrogenated Resin (a thermoplastic, acidic resin produced by hydrogenating rosin to an exceptionally high degree), FORALYN™ E Partially Hydrogenated Resin (another thermoplastic, acidic resin made by partially hydrogenating rosin), or FORAL™ 85-E Ester of Hydrogenated Rosin (thermoplastic ester resin derived from glycerol and a highly stabilized rosin), all available from Eastman Chemical Company, or QUINTONE™ N180 (an aliphatic hydrocarbon resin, C5/C9 type), available from Zeon Chemicals. The aforementioned tackifiers are either aliphatic (C5) or aromatic (C9) tackifiers. If aromatic tackifiers are used, they may be hydrogenated, which can reduce the moisture vapor transmission rate of the encapsulant material. Using tackifiers with softening points ranging from about 90° C. to about 105° C. can also reduce the moisture vapor transmission rate of the encapsulant material, although this may require higher mixing and dispensing temperatures.

Regardless of the specific type of tackifier used in the described polyisobutylene-based encapsulant material, it may be present in an amount ranging from about 3% by weight to 25% by weight of the total polyisobutylene-based encapsulant composition. This concentration range ensures that the polyisobutylene-based encapsulant does not demonstrate brittleness at lower temperatures. In one embodiment, the tackifier may be present in an amount ranging from about 3% by weight to about 15% by weight of the total polyisobutylene-based encapsulant composition. In another embodiment, the tackifier may be present in an amount ranging from about 5% by weight to about 10% by weight of the total polyisobutylene-based encapsulant composition.

Additionally, the polyisobutylene-based encapsulant may include a polymer, which adds toughness to the polyisobutylene-based encapsulant. The polymer may include a polyolefin, or an ethylene-propylene copolymer. A polyolefin is a polymer produced from a simple olefin (also called an alkene with the general formula CₙH₂ₙ) as a monomer. Being saturated hydrocarbons, in general, polyolefins are chemically inert, electrically non-polar, and highly electrically insulating. An equivalent term for a polyolefin is a polyalkene. Polyolefins may be thermoplastic such as polyalphaolefin, polyethylene (PE), polypropylene (PP), polymethylpentene (PMP), and polybutene-1 (PB-1). Elastomeric polyolefins may include ethylene propylene rubber (EPR), and ethylene propylene diene monomer (M-class) rubber (EPDM rubber).

In one embodiment, VESTOPLAST® 704, an amorphous poly-alpha-olefin available from Evonik Degussa GmbH, may be used in the polyisobutylene-based encapsulant composition. VESTOPLAST® 704 is an amorphous polyalphaolefin having a softening point of about 105° C., a melt viscosity ranging from about 3000 centipoise to about 4000 centipoise at 190° C. Amorphous polyalphaolefins (APAOs) are polymers of α-olefins (for example co- and ter-polymers of ethene, propene and 1-butene). In another embodiment, the polymer may include other amorphous poly-alpha-olefins, such as VESTOPLAST® 703 and VESTOPLAST® EP NC 702, also available from Evonik Degussa GmbH. In another embodiment, the polymer may include AFFINITY® GA 1900, which is a low viscosity polyolefin available from Dow Chemical Company. In yet another embodiment, the polymer may also include an ethylene-propylene copolymer that can further be combined with silica, such as TRILENE FREEFLOW® CP80 available from Lion Copolymer, LLC, which is a free-flowing ethylene-propylene polymer made by combining the liquid polymer with silica. The blend of ethylene-propylene polymer and silica may include 68% ethylene-propylene copolymer and 32% silica.

Regardless of the specific type of polymer used in the described polyisobutylene-based encapsulant material, it may be present in an amount ranging from about 5% by weight to about 26% by weight of the total polyisobutylene-based encapsulant composition, which ensures that the polyisobutylene-based encapsulant does not demonstrate brittleness at low temperatures. In one embodiment the polymer may be present in an amount ranging from about 10% by weight to about 20% by weight of the total polyisobutylene-based encapsulant composition.

The polyisobutylene-based encapsulant may also contain a thermoplastic elastomer to allow a liquid transition when the polyisobutylene-based encapsulant materials are heated to a temperature greater than about 120° C. The thermoplastic elastomer may include linear or branched styrenic block copolymers, polyolefin blends, thermoplastic polyurethanes, thermoplastic copolyesters, or thermoplastic polyamides. In one embodiment, the thermoplastic elastomer may include a linear block copolymer based on styrene and ethylene/butylene having a melt flow rate in ranging from about 1 g/10 min to about 30 g/10 min and a tensile strength ranging from about 10 MPa to about 35 MPa. In another embodiment the thermoplastic elastomer may include KRATON® 1654, which is available from Kraton Performance Polymers Inc.

Regardless of the specific type of thermoplastic elastomer used in the described polyisobutylene-based encapsulant material, it may be present in an amount ranging from about 0.1% by weight to 6% by weight of the total polyisobutylene-based encapsulant composition. In one embodiment the polymer may be present in an amount ranging from about 2.5% by weight to about 4% by weight of the total polyisobutylene-based encapsulant composition.

One more component of the polyisobutylene-based encapsulant may be an antioxidant used to prevent oxidation of the resin. Antioxidants are widely used to prevent the oxidative degradation of polymers such as rubbers, plastics and adhesives that causes a loss of strength and flexibility in these materials. Polymers containing double bonds in their main chain may be especially susceptible to oxidation. In one embodiment the antioxidant may include NA-Lube AO 220 (BHT), available from King Industries. This phenolic antioxidant has the chemical composition 2,6 di-tert-butyl-p-cresol and is a 100% active phenolic antioxidant. It is a general purpose antioxidant with a low melting point of about 69° C. that liquefies with minimal heat. In another embodiment the antioxidant may include other phenolic antioxidants, aromatic amines, or gallic acid esters. Regardless of the type of antioxidant used in the polyisobutylene-based encapsulant, it may be present in a range of about 0.05% to 0.15% by weight.

The polyisobutylene-based encapsulant may include the combination of: the polyisobutylene being present in an amount ranging from about 50% by weight to about 95% by weight of the polyisobutylene-based encapsulant; the tackifier being present in an amount ranging from about 3% by weight to about 25% by weight of the polyisobutylene-based encapsulant; the polymer being present in an amount ranging from about 5% by weight to about 25% by weight of the polyisobutylene-based encapsulant; and the thermoplastic elastomer being present in an amount ranging from about 0.1% by weight to about 6% by weight of the polyisobutylene-based encapsulant. In another embodiment, the polyisobutylene-based encapsulant may include: the polyisobutylene being present in an amount ranging from about 70% by weight to about 80% by weight of the polyisobutylene-based encapsulant; the tackifier being present in an amount ranging from about 5% by weight to about 11% by weight of the polyisobutylene-based encapsulant; the polymer being present in an amount ranging from about 11% by weight to about 18% by weight of the polyisobutylene-based encapsulant; and the thermoplastic elastomer being present in an amount less than about 6% by weight of the polyisobutylene-based encapsulant. In another embodiment, the encapsulant may include: the polyisobutylene being present in an amount of about 75% by weight of the polyisobutylene-based encapsulant; the tackifier being present in an amount of about 6.3% by weight of the polyisobutylene-based encapsulant; the polymer being present in an amount of about 15.8% by weight of the polyisobutylene-based encapsulant; and the thermoplastic elastomer being present in an amount of about 2.8% by weight of the polyisobutylene-based encapsulant. In another embodiment, the polyisobutylene-based encapsulant may include: the polyisobutylene being present in an amount of about 75% by weight of the polyisobutylene-based encapsulant; the tackifier being present in an amount of about 7.1% by weight of the polyisobutylene-based encapsulant; the polymer being present in an amount of about 17.9% by weight of the polyisobutylene-based encapsulant; and the thermoplastic elastomer being present in an amount of about 0.1% by weight of the polyisobutylene-based encapsulant. In another embodiment, the polyisobutylene-based encapsulant may include: the polyisobutylene being present in an amount of about 75% by weight of the polyisobutylene-based encapsulant; the tackifier being present in an amount of about 9.3% by weight of the polyisobutylene-based encapsulant; the polymer being present in an amount of about 11.5% by weight of the polyisobutylene-based encapsulant; and the thermoplastic elastomer being present in an amount of about 4.2% by weight of the polyisobutylene-based encapsulant. In yet another embodiment, the polyisobutylene-based encapsulant may include: the polyisobutylene being present in an amount of about 75% by weight of the polyisobutylene-based encapsulant; the tackifier being present in an amount of about 10.1% by weight of the polyisobutylene-based encapsulant; the polymer being present in an amount of about 12.6% by weight of the polyisobutylene-based encapsulant; and the thermoplastic elastomer being present in an amount of about 2.3% by weight of the polyisobutylene-based encapsulant.

The polyisobutylene-based encapsulant composition may also include any combination of polyisobutylenes, tackifiers, polymers, and thermoplastic elastomers. In one embodiment, the polyisobutylene-based encapsulant composition may include TPC® 1105 as the polyisobutylene, NEVTAC® 201 as the tackifier, VESTOPLAST® 704 as the polymer, and KRATON® 1654 as the thermoplastic elastomer.

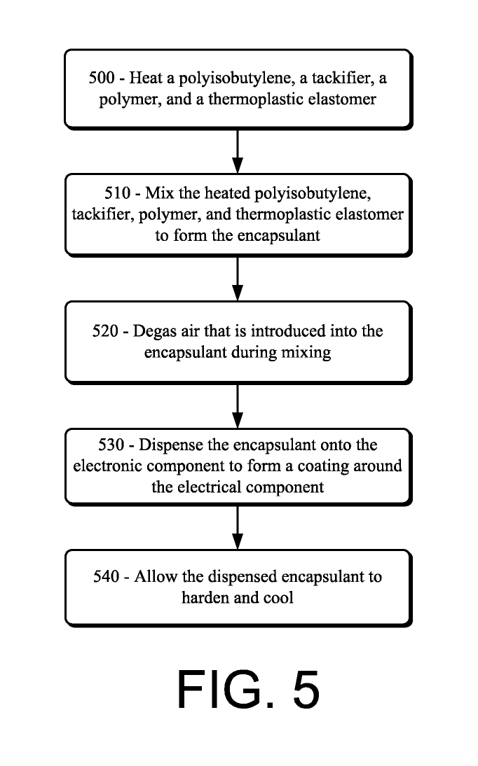

FIG. 5 shows an example of forming and utilizing an encapsulant. At step 500, the polyisobutylene-based encapsulant may be made by heating a polyisobutylene, a tackifier, a polymer, and a thermoplastic elastomer, at a temperature ranging from about 100° C. to about 150° C. At step 510, the heated polyisobutylene, tackifier, polymer, and thermoplastic elastomer are mixed at a temperature ranging from about 100° C. to about 150° C. The higher temperatures may facilitate and accelerate the dispersion of the materials. In the example of step 520, after the polyisobutylene-based encapsulant is mixed, it may be degassed to remove any air that is introduced into the polyisobutylene-based encapsulant during mixing. In an alternative embodiment, the mixing step described above may occur under vacuum and at a speed ranging from about 100 RPM to about 500 RPM for a time ranging from about 1 hour to about 6 hours. In the example of step 530, the mixed polyisobutylene-based encapsulant may then be dispensed around any desired electrical components at a temperature ranging from about 100° C. to about 150° C. and a viscosity ranging from about 2000 centipoise to about 3000 centipoise. Any electrical components may also be preheated to a temperature ranging from about 100° C. to about 150° C., which can reduce shrinkage or pulling away of the polyisobutylene-based encapsulant from the electrical components after cooling due to temperature mismatch. In the example of step 540, after the polyisobutylene-based encapsulant has been dispensed around an electronic component to form a coating, the coated electronic component, which is now encapsulated, may be allowed to harden and cool before use.

Example polyisobutylene-based encapsulants formed from the components described above have been tested alongside an epoxy-based control to determine moisture barrier properties as compared to the control. Table 1 summarizes the components of the polyisobutylene-based encapsulants used in testing:

TABLE 1
Tested Encapsulants

| | | Composition | Composition | Composition |
|---|---|---|---|---|
| Component | Name | 1 Weight % | 2 Weight % | 3 Weight % |
| Polyisobutylene | TPC 1105 | 69.9 | 69.9 | 50 |
| Tackifier | Nevtac | 12 | 12 | 22 |
| | 201 | | | |
| Polymer | Vestoplast | 18 | 11 | 26 |
| | 704 | | | |
| Thermoplastic | Kraton | 0.1 | 7 | 2 |
| Elastomer | 1654 | | | |

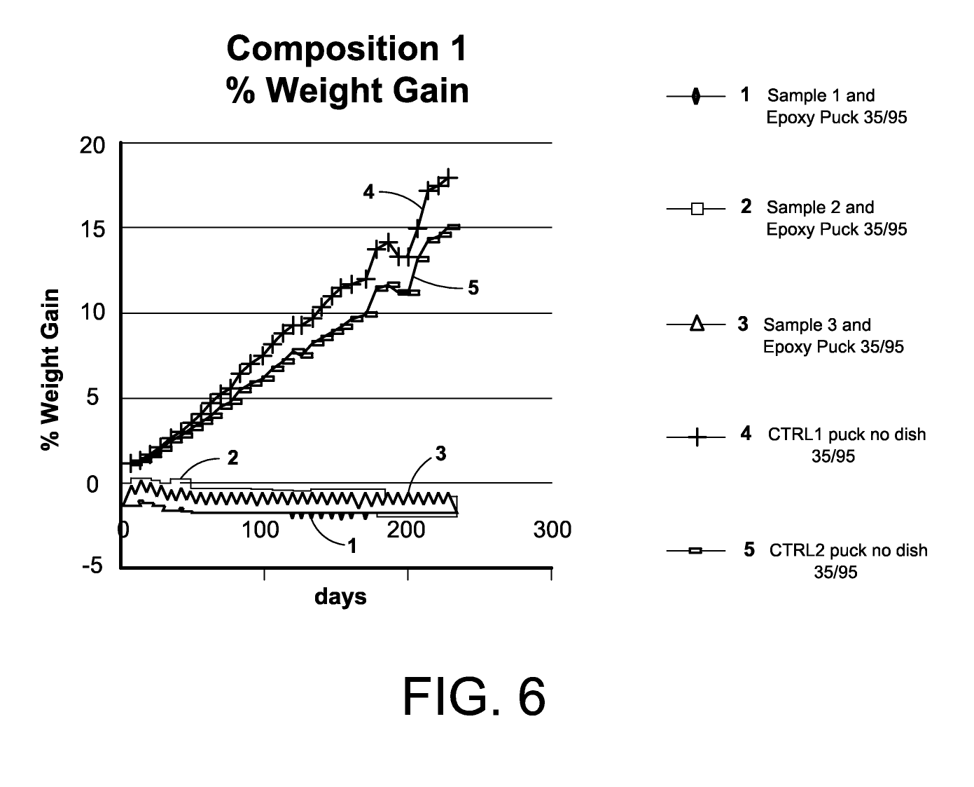

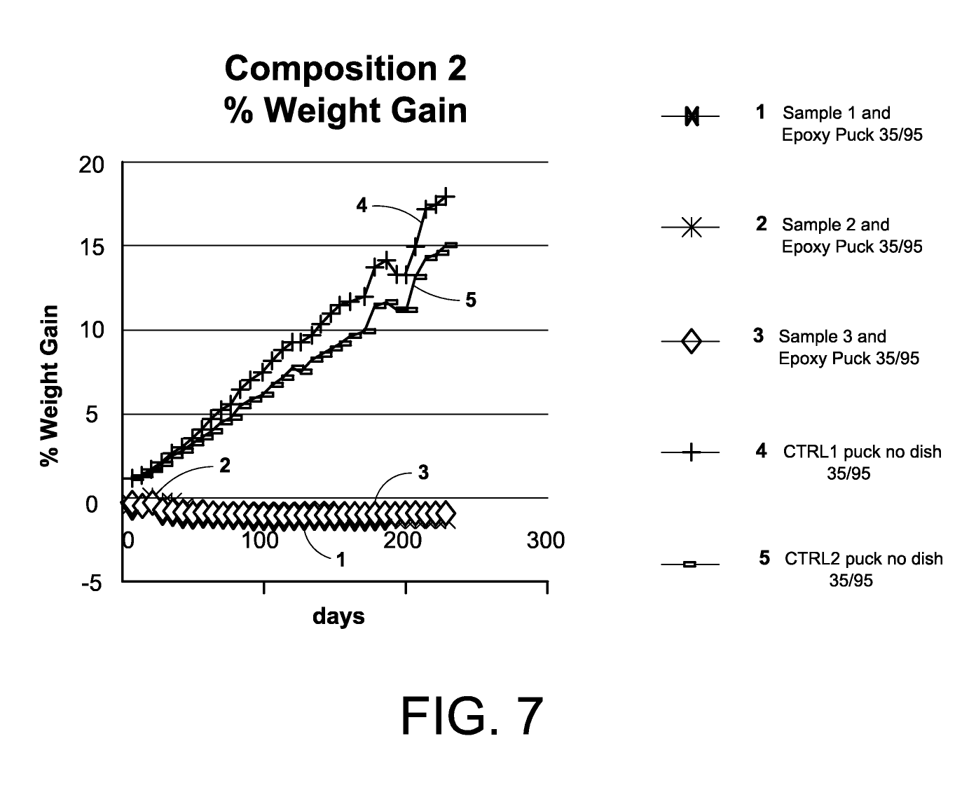

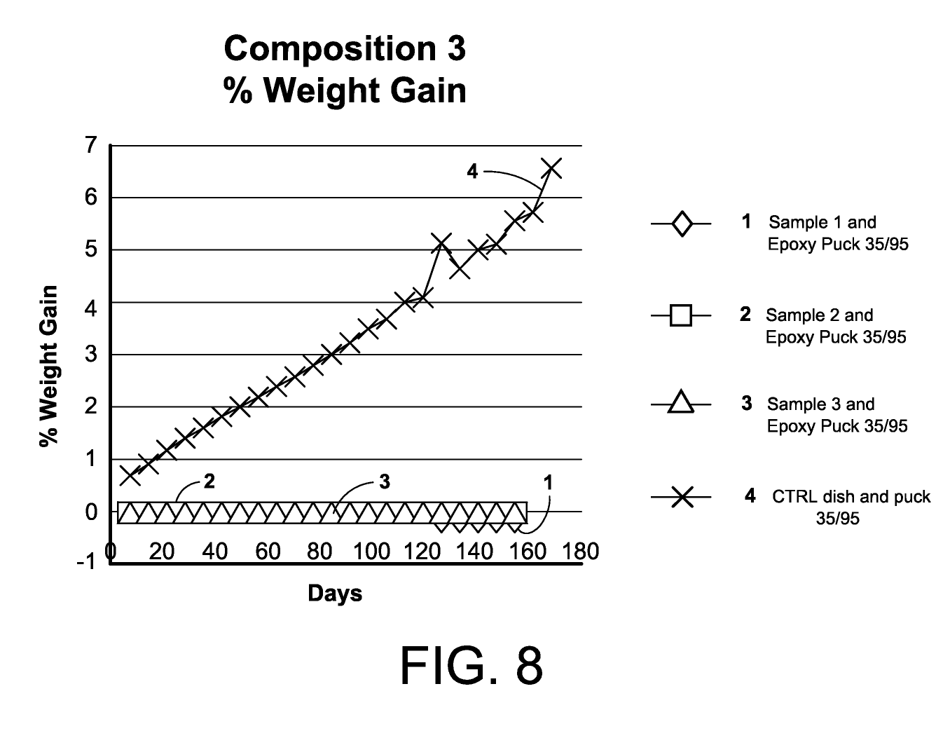

In the tests, the epoxy-based control was coated with the polyisobutylene-based encapsulants as described in Table 1, which were compared to the epoxy-based control having no coating. The percent weight gains, which can be attributed to the diffusion of moisture through the polyisobutylene-based encapsulant of the above samples and the control, were measured over a length of time at fixed temperature and relative humidity. The results of the testing for each composition are shown in FIG. 6, FIG. 7, and FIG. 8 respectively. As evidenced by FIG. 6-8, the test samples coated with the polyisobutylene-based encapsulant of the present disclosure exhibited significantly lower percent weight gain than the controls, signaling their improved moisture barrier properties, which can be associated with a lower permeability and a lower moisture vapor transmission rate. In one embodiment, the encapsulant may exhibit a percent weight gain of less than about 5% by weight over a period of about 200 days at a temperature of about 35° C. and a relative humidity of about 95%. In another embodiment, the polyisobutylene-based encapsulant may exhibit a percent weight gain of less than about 1% by weight over a period of about 200 days at a temperature of about 35° C. and a relative humidity of about 95%. In yet another embodiment, the polyisobutylene-based encapsulant may exhibit a percent weight gain of about 0.1% by weight over a period of about 200 days at a temperature of about 35° C. and a relative humidity of about 95%.

More specifically, Compositions 1, 2, and 3 and the epoxy controls were tested over a period of about 200 days at 35° C. and 95% relative humidity. By 200 days, the epoxy control for Composition 1, shown as label 4 and 5 on FIG. 6, exhibited a percent weight gain ranging from about 11% to about 15%; and the epoxy control for Composition 2, shown as label 4 and 5 on FIG. 7, exhibited a similar percent weight gain ranging from about 11% to about 15%. Meanwhile, the three samples coated with Composition 1 shown as labels 1, 2, and 3 on FIG. 6, and the three samples coated with Composition 2 shown as labels 1, 2, and 3 on FIG. 7, exhibited a percent weight gain of less than about 0.1%.

For Composition 3, by 160 days, the epoxy control, shown as label 4 on FIG. 8, exhibited a percent weight gain of about 15%. Meanwhile, the three samples coated with Composition 3 shown as labels 1, 2, and 3 on FIG. 8 exhibited a percent weight gain of less than about 0.1%.

These results demonstrate that the polyisobutylene-based encapsulant of the present disclosure can provide for improved moisture barrier properties over current potting materials, such as a reduced moisture vapor transmission rate over current potting materials, such as the epoxy control, as shown by the small % weight gain due to moisture of the described polyisobutylene-based encapsulant material.

While the presently disclosed subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the presently disclosed subject matter and appended claims as would be readily apparent to one of ordinary skill in the art.

What is claimed is:

1. An encapsulant for use with electronic components, comprising:
a polyisobutylene;
a tackifier;
a polymer; and
a thermoplastic elastomer.

2. The encapsulant of claim 1, wherein the polyisobutylene is present in an amount ranging from about 50% by weight to about 95% by weight of the encapsulant.

3. The encapsulant of claim 1, wherein the tackifier is present in an amount ranging from about 3% by weight to about 25% by weight of the encapsulant.

4. The encapsulant of claim 1, wherein the tackifier includes a hydrocarbon resin; a glycol ester of partially hydrogenated rosin; a thermoplastic, acid resin; or a thermoplastic ester resin.

5. The encapsulant of claim 1, wherein the polymer is present in an amount ranging from about 5% by weight to about 26% by weight of the encapsulant.

6. The encapsulant of claim 1, wherein the polymer includes a polyolefin or an ethylene-propylene copolymer.

7. The encapsulant of claim 1, wherein the thermoplastic elastomer is present in an amount ranging from about 0.1% by weight to about 6% by weight of the encapsulant.

8. The encapsulant of claim 1, further comprising an antioxidant, wherein the antioxidant is present in an amount ranging from about 0.05% by weight to about 0.15% by weight of the encapsulant.

9. The encapsulant of claim 1, wherein the encapsulant exhibits a percent weight gain of less than about 1% by weight over a period of about 200 days at a temperature of about 35° C. and a relative humidity of about 95%.

10. A method of forming an encapsulant on an electronic component, comprising:
heating a polyisobutylene, a tackifier, a polymer, and a thermoplastic elastomer, wherein the heating occurs at a temperature ranging from about 100° C. to about 150° C.; and
mixing the heated polyisobutylene, tackifier, polymer, and thermoplastic elastomer to form an encapsulant.

11. The method of claim 10, further comprising degassing any air that is introduced into the encapsulant during mixing.

12. The method of claim 10, wherein the mixing occurs under vacuum and at a speed ranging from about 100 RPM to about 500 RPM for a time ranging from about 1 hour to about 6 hours.

13. The method of claim 10, further comprising:
dispensing the encapsulant around an electrical component to form a coating around the electrical component; and
allowing the coated electrical component to harden and cool.

14. The method of claim 13, wherein the encapsulant is dispensed at a temperature ranging from about 100° C. to about 150° C. and has a viscosity ranging from about 125 centipoise to about 10000 centipoise when dispensed.

15. The method of claim 10, wherein the polyisobutylene is present in an amount ranging from about 50% by weight to about 95% by weight of the encapsulant.

16. The method of claim 10, wherein the tackifier is present in an amount ranging from about 3% by weight to about 15% by weight of the encapsulant.

17. The method of claim 10, wherein the polymer is present in an amount ranging from about 5% by weight to about 26% by weight of the encapsulant.

18. The method of claim 10, wherein the thermoplastic elastomer is present in an amount ranging from about 0.1% by weight to about 6% by weight of the encapsulant.

19. The method of claim 10, wherein the heating and mixing further includes an antioxidant, wherein the antioxidant is present in an amount ranging from about 0.05% by weight to about 0.15% by weight of the encapsulant.

20. An electronic component having an encapsulant, comprising:
a polyisobutylene, wherein the polyisobutylene is present in an amount ranging from about 50% by weight to about 95% by weight of the encapsulant;
a tackifier, wherein the tackifier is present in an amount ranging from about 3% by weight to about 15% by weight of the encapsulant;
a polymer, wherein the polymer is present in an amount ranging from about 5% by weight to about 25% by weight of the encapsulant;
a thermoplastic elastomer, wherein the thermoplastic elastomer is present in an amount ranging from about 0.1% by weight to about 6% by weight of the encapsulant; and
an antioxidant, wherein the antioxidant is present in an amount ranging from about 0.05% by weight to about 0.15% by weight of the encapsulant.
